(19) United States
(12) Patent Application Publication
(10) Pub. No.: US 2017/0316624 A1
(43) Pub. Date: Nov. 2, 2017

(54) MOBILE EQUIPMENT MAINTENANCE MONITORING SYSTEM

(71) Applicant: Carrier Corporation, Farmington, CT (US)

(72) Inventor: James Casasanta, Auburn, NY (US)

(73) Assignee: Carrier Corporation, Farmington, CT (US)

(21) Appl. No.: 15/520,481

(22) PCT Filed: Oct. 21, 2015
(86) PCT No.: PCT/US2015/056693

§ 371 Date: Apr. 20, 2017

Related U.S. Application Data
(60) Provisional application No. 62/067,624, filed on Oct. 23, 2014.

(51) Int. Cl. G07C 5/08; G07C 5/00

(52) U.S. Cl. CPC G07C 5/0816; G07C 5/006; G07C 5/008

(57) ABSTRACT

A mobile equipment maintenance monitoring system includes one or more sensors configured and disposed to detect non-time-based parameter of a mobile equipment component and a controller operatively coupled to the one or more sensors. The controller includes a wireless communication device configured and disposed to wirelessly communicate a maintenance alert to a remote monitoring system.

### BACKGROUND OF THE INVENTION

Exemplary embodiments pertain to the art of mobile systems and, more particularly, to a maintenance monitoring system for mobile equipment.

Mobile equipment may experience unplanned down time resulting from a component failure. The component failure may lead to an unplanned repair that could prevent the mobile equipment from being fielded or result in lost product. Often times, fleet operators employ a maintenance schedule to reduce unplanned downtime. The maintenance schedule may rely on hours operated, miles traveled or other metrics to determine when a particular maintenance operation may be warranted.

### BRIEF DESCRIPTION OF THE INVENTION

Disclosed is a mobile equipment maintenance monitoring system including one or more sensors configured and disposed to detect a non-time-based parameter of a mobile equipment component and a controller operatively coupled to the one or more sensors. The controller includes a wireless communication device configured and disposed to wirelessly communicate a maintenance alert to a remote monitoring system.

Also disclosed is a mobile equipment system including a mobile equipment component and a mobile equipment maintenance monitoring system operatively connected to the mobile equipment component. The mobile equipment maintenance system includes one or more sensors configured and disposed to detect a non-time-based parameter of the mobile equipment component and a controller operatively coupled to the one or more sensors. The controller includes a wireless communication device configured and disposed to wirelessly communicate a maintenance alert to a remote monitoring system.

Further disclosed is a method of monitoring a mobile equipment component. The method includes detecting a non-time-based parameter of the mobile equipment component, determining whether the non-time-based parameter exceeds a non-time-based parameter threshold, and wirelessly signaling a maintenance need if the non-time-based parameter exceeds the non-time-based parameter threshold.

### BRIEF DESCRIPTION OF THE DRAWINGS

The following descriptions should not be considered limiting in any way. With reference to the accompanying drawings, like elements are numbered alike:

FIG. 1 depicts a mobile equipment system including a mobile equipment maintenance monitoring system, in accordance with an exemplary embodiment;

FIG. 2 depicts a block diagram illustrating the mobile equipment maintenance monitoring system of FIG. 1; and

FIG. 3 depicts a flow chart illustrating a method of monitoring a mobile equipment component, in accordance with an aspect of an exemplary embodiment.

### DETAILED DESCRIPTION OF THE INVENTION

A detailed description of one or more embodiments of the disclosed apparatus and method are presented herein by way of exemplification and not limitation with reference to the Figures.

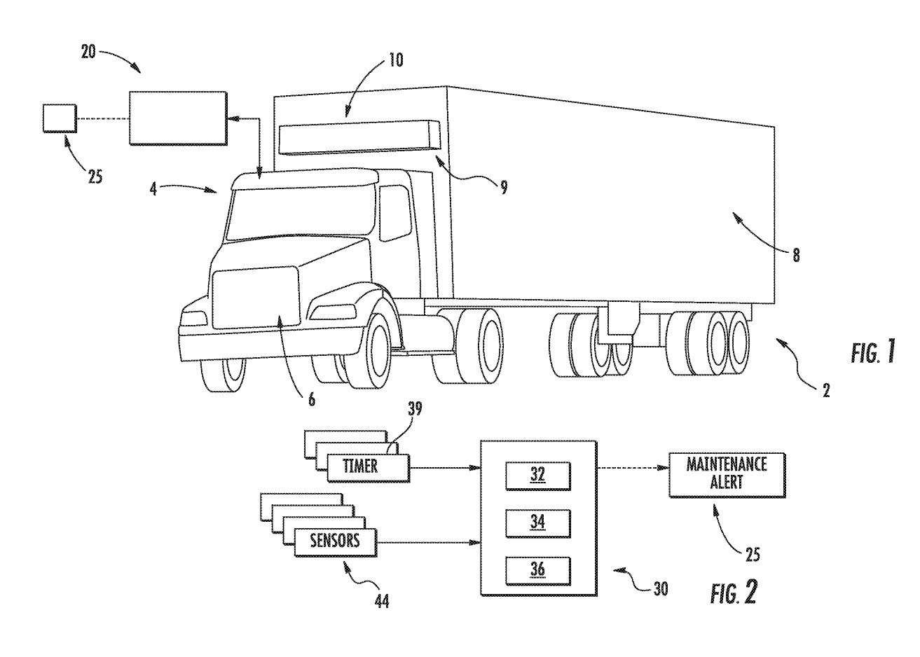

A mobile equipment system, in accordance with an exemplary embodiment, is indicated generally at 2, in FIG. 1. Mobile equipment system 2 is shown in the form of a semi-trailer 4 including a tractor/truck portion 6 and a trailer portion 8. Trailer portion 8 includes a mobile equipment component 9 shown in the form of a refrigeration system 10. Truck portion 6 provides a motive force to tractor portion 8. Truck portion 6 may also provide power to refrigeration system 10 arranged with trailer portion 8. More specifically, truck portion 6 may be mechanically linked to and/or electrically coupled with refrigeration system 10. At this point, it should be understood that mobile equipment system 2 may take on numerous forms including various overland and oversea transportation systems. It should also be understood that mobile equipment component 9 may also take on various forms.

In accordance with an exemplary embodiment, mobile equipment system 2 includes a mobile equipment maintenance monitoring system 20 operatively coupled to truck portion 6 and mobile equipment component 9. As shown in FIG. 2, mobile equipment maintenance monitoring system 20 includes a remote monitoring system 25 including a controller 30 having a central processor unit (CPU) 32, a memory module 34, and a communication module 36. Communication module 36 may take the form of a satellite communication device and/or a cellular communication device. Controller 30 is operatively connected to one or more timers 39 that monitor time-based parameters associated with truck portion 6, trailer portion 8 and/or mobile equipment component 9. The time-based parameters are passed to controller 30 and compared with values stored in memory module 34 to determine whether a time-based maintenance interval is indicated. Time-based maintenance intervals may include fluid changes, tire changes, system checks, and the like.

In further accordance with an exemplary embodiment, mobile equipment maintenance monitoring system 20 includes one or more non-time-based sensors 44. Non-time-based sensors 44 may take the form of accelerometers or vibration sensors, pressure sensors, temperature sensors, and the like. Non-time-based sensors 44 detect non-time-based parameters associated with mobile equipment system 2. The term “non-time-based” should be understood to define parameters that do not rely on time and distance traveled by mobile equipment system 2. For example, non-time-based parameters may include monitoring vibration parameters, pressure parameters, and/or temperature parameters associated with refrigeration system 10. As will be discussed below, monitoring non-time-based parameters associated with refrigeration system 10 will reduce unplanned downtime of mobile equipment system 2.

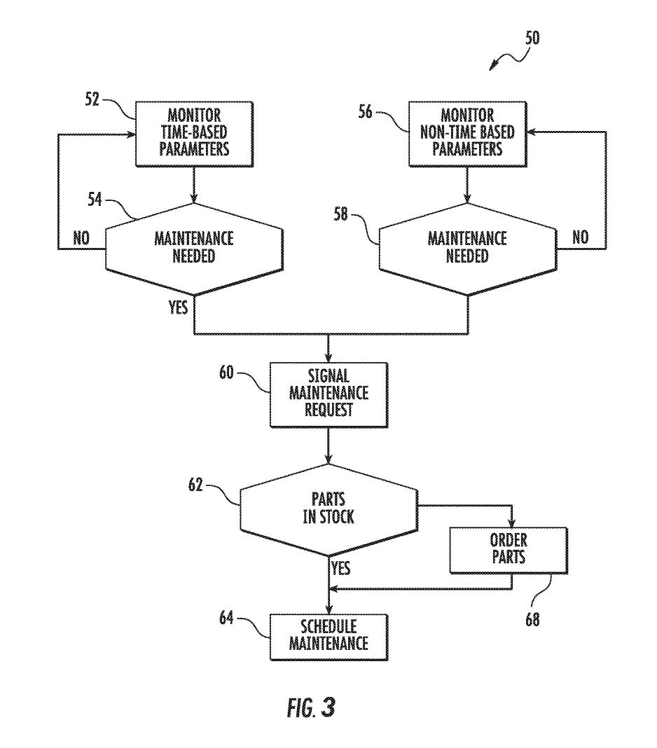

Reference will now follow to FIG. 3 in describing a method 50 of monitoring mobile equipment system 2. In block 52, timers 39 monitor time-based parameters associated with mobile equipment system 2. In block 54, a determination is made whether a time-based maintenance interval is indicated. A time-based maintenance interval may include a fluid change, tire check, or other system check. Non-time-based parameters are monitored in block 56. In block 58, a determination is made whether a non-time-based maintenance interval is indicated. If in either block 54 or block 58 a maintenance interval is indicated, a maintenance request is generated in block 60. The maintenance request is communicated, via communication module 36, to remote monitoring system 25. Remote monitoring system 25 may take the form of a web portal, a fleet maintenance system or the like, associated with mobile equipment system 2.

A determination is made in block 62 whether parts needed for the maintenance are in stock at one or more maintenance facilities. At this point, mobile equipment system 2 may be directed to a scheduled maintenance interval in block 64 at a maintenance location that has the necessary parts in stock. If parts are not in stock, an order request may be made in block 68 before directing the mobile equipment system 2 to a maintenance interval.

At this point it should be understood that the exemplary embodiments describe a system that monitors non-time-based parameters associated with a mobile equipment system to reduce unscheduled maintenance. Monitoring non-time-based parameters, such as accelerations, could determine when mobile equipment component motions are approaching typical displacement limits. For example, excessive refrigeration compressor motion could signal a need to replace vibrasorbers. In this manner, ancillary component damage and unscheduled maintenance may be reduced. Further, communicating the need for maintenance to a remote monitoring station may reduce downtime further by directing the mobile equipment to a nearby maintenance facility, or arrange for maintenance at another convenient facility that includes in stock parts, as time permits.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A mobile equipment maintenance monitoring system comprising:
one or more sensors configured and disposed to detect a non-time-based parameter of a mobile equipment component; and
a controller operatively coupled to the one or more sensors, the controller including a wireless communication device configured and disposed to wirelessly communicate a maintenance alert to a remote monitoring system.

2. The mobile equipment maintenance monitoring system according to claim 1, wherein the non-time-based parameter includes a vibration parameter.

3. The mobile equipment maintenance monitoring system according to claim 1, wherein the non-time-based parameter includes at least one of a pressure parameter and a temperature parameter.

4. The mobile equipment maintenance monitoring system according to claim 1, wherein the mobile equipment component includes a refrigeration system.

5. The mobile equipment maintenance monitoring system according to claim 1, wherein the wireless communication device comprises a satellite communication device.

6. The mobile equipment maintenance monitoring system according to claim 1, wherein the wireless communication device comprises a cellular communication device.

7. The mobile equipment maintenance monitoring system according to claim 1, further comprising: at least one timer configured and disposed to determine a time-based parameter of a mobile equipment component.

8. A mobile equipment system comprising:
a mobile equipment component; and
a mobile equipment maintenance monitoring system operatively connected to the mobile equipment component, the mobile equipment maintenance system comprising:
one or more sensors configured and disposed to detect a non-time-based parameter of the mobile equipment component; and
a controller operatively coupled to the one or more sensors, the controller including a wireless communication device configured and disposed to wirelessly communicate a maintenance alert to a remote monitoring system.

9. The mobile equipment system according to claim 8, wherein the non-time-based parameter includes a vibration parameter.

10. The mobile equipment system according to claim 8, wherein the non-time-based parameter includes at least one of a pressure parameter and a temperature parameter.

11. The mobile equipment system according to claim 8, wherein the mobile equipment component includes a refrigeration system.

12. The mobile equipment system according to claim 8, wherein the wireless communication device comprises a satellite communication device.

13. The mobile equipment system according to claim 8, wherein the wireless communication device comprises a cellular communication device.

14. The mobile equipment system according to claim 8, further comprising: at least one timer configured and disposed to determine a time-based parameter of a mobile equipment component.

15. A method of monitoring a mobile equipment component comprising:
detecting a non-time-based parameter of the mobile equipment component;
determining whether the non-time-based parameter exceeds a non-time-based parameter threshold; and
wirelessly signaling a maintenance need if the non-time-based parameter exceeds the non-time-based parameter threshold.

16. The method of claim 15, wherein detecting the non-time-based parameter includes detecting a vibration parameter.

17. The method of claim 16, wherein detecting the non-time-based parameter includes detecting at least one of a pressure parameter and a temperature parameter.

18. The method of claim 15, wherein wirelessly signaling the maintenance need includes communicating with a satellite communications system.

19. The method of claim 15, wherein wirelessly signaling the maintenance need includes communicating with a cellular communications system.

20. The method of claim 15, further comprising: detecting a time-based parameter of a mobile equipment component.
